(19) United States
(12) Patent Application Publication
(10) Pub. No.: US 2017/0197451 A1
(43) Pub. Date: Jul. 13, 2017

(54) Notebook Having Removable Pages

(71) Applicant: Dave Gray, Webster Groves, MO (US)

(72) Inventor: Dave Gray, Webster Groves, MO (US)

(21) Appl. No.: 15/081,690

(22) Filed: Mar. 25, 2016

Related U.S. Application Data
(60) Provisional application No. 62/277,174, filed on Jan. 11, 2016.

(51) Int. Cl. B42D 5/00; B42F 5/00; B42D 3/12; B42C 9/00

(52) U.S. Cl. CPC B42D 5/003; B42C 9/0006; B42F 5/00; B42D 3/12

(57) ABSTRACT

Disclosed are exemplary embodiments of notebooks and related methods. In an exemplary embodiment, a notebook generally includes two covers connected by a spine. A binding is connected with the covers and has a central strip portion to which pages are removably attached. The binding and pages are housed between the covers when the notebook is closed. At least part of the central strip portion of the binding is capable of movement away from the spine when the notebook is opened. A folder is inside the notebook adjacent one of the covers. The folder has flaps openable to allow placement of pages onto the folder when the pages have been removed from the binding. The flaps are closable over the placed pages to retain the pages, whole and unfolded, in the folder.

### CROSS-REFERENCE TO RELATED APPLICATIONS

This application claims the benefit of U.S. Provisional Application No. 62/277,174, filed on Jan. 11, 2016. The entire disclosure of the above application is incorporated herein by reference.

### FIELD

The present disclosure generally relates to notebooks, and more particularly (but not exclusively) to a notebook having removable pages.

### BACKGROUND

This section provides background information related to the present disclosure which is not necessarily prior art.

Artists, architects, authors and others often keep a sketchbook or notebook handy so that they might readily capture an image or idea on paper. Ad-hoc sketches and notes frequently provide the subject matter for larger and more detailed works.

### DRAWINGS

The drawings described herein are for illustrative purposes only of selected embodiments and not all possible implementations, and are not intended to limit the scope of the present disclosure.

FIGS. 1 through 4 are perspective views of a notebook according to an exemplary embodiment.

Corresponding reference numerals indicate corresponding parts throughout the several views of the drawings.

### DETAILED DESCRIPTION

Example embodiments will now be described more fully with reference to the accompanying drawings.

The inventor hereof has recognized that users of notebooks and sketchbooks often want to digitize contents of a notebook or sketchbook, e.g., after the notebook has been filled with notes and/or sketches. Notebook contents, however, typically are not easy to digitize. One usually has to open a notebook and place it on a flatbed scanner and scan it, one double-page spread (or one page) at a time. The scanning process can be time consuming and cumbersome, especially when a notebook has a stiff binding that makes it difficult to lay the pages completely flat onto the scanner bed. Book scanners are available that automatically turn pages for scanning, but such scanners are very expensive. The inventor also has observed that notebook users at times want to remove notebook pages that contain writings and/or drawings, and that users often wish to preserve, in their original form, pages that have been removed from a notebook or sketchbook.

Accordingly, the inventor has developed and discloses herein exemplary embodiments of a notebook having two covers connected by a spine. The example notebook also has a binding connected with the covers. The binding has a central strip portion to which pages are attached. The pages are completely removable from the central strip portion. The binding and pages are housed between the covers when the notebook is closed. At least part of the central strip portion of the binding is capable of moving, e.g., flexing, away from the spine when the notebook is opened. A folder is attached inside the notebook on one of the covers. The folder has a plurality of flaps openable to allow placement of one or more of the pages in the folder when the page(s) have been removed from the binding. The flaps are closable over the page(s) placed in the folder. The flaps can retain the page(s), whole and unfolded, in the folder.

It should be noted that although various embodiments are described in the present disclosure and claims with reference to notebooks, the disclosure is not so limited. Embodiments also are contemplated in relation to sketchbooks, workbooks, diaries, journals, etc. Thus, unless otherwise indicated, the term “notebook” as used herein includes sketchbooks, workbooks, diaries, journals, etc.

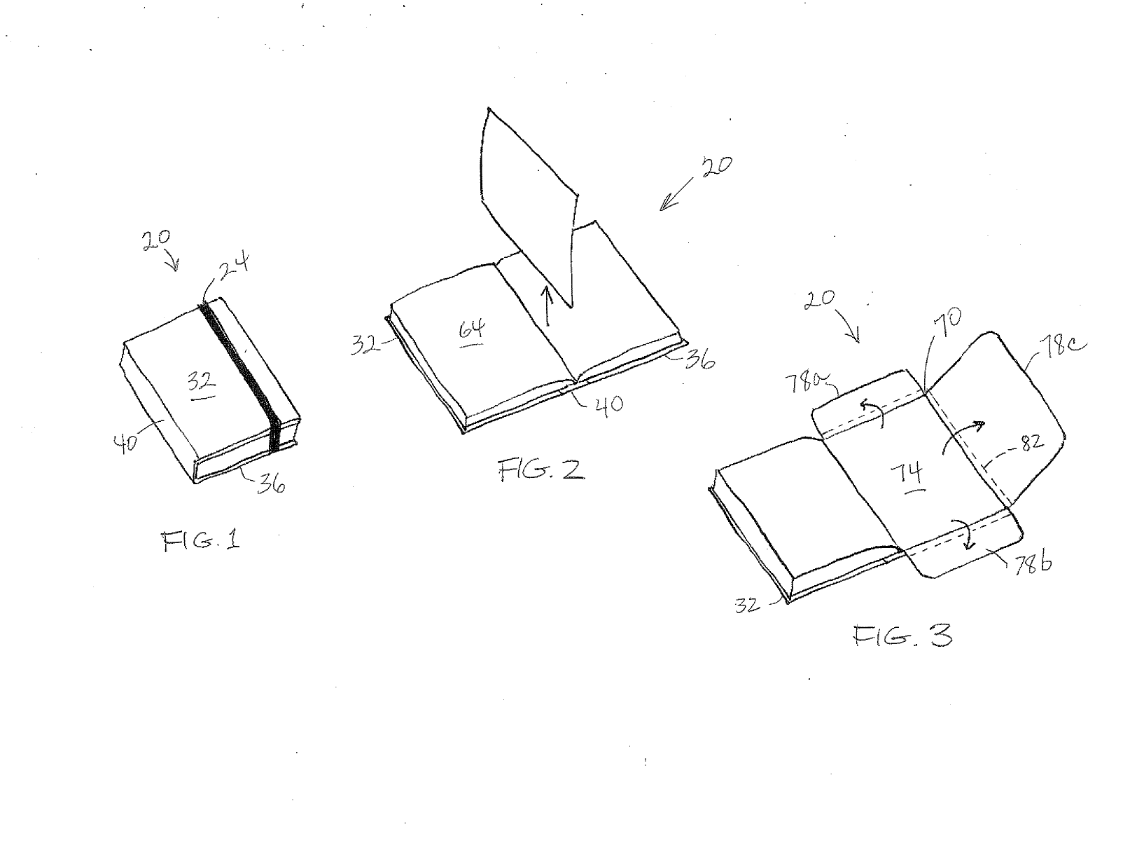

With reference now to the figures, FIGS. 1 through 4 illustrate an exemplary embodiment of a notebook embodying one or more aspects of the present disclosure. FIG. 1 illustrates a notebook 20 that is closed and held closed by a strap or band 24. The band 24 may be made of various materials, including but not limited to elastic, plastic, rubber, etc. The band 24 may be totally separable from the notebook 20 or may be partly attached to the notebook 20 so that, e.g., the band 24 cannot be lost when removed from around the notebook 20. In some embodiments, the band 24 may have a clasp or tie by which the band may be opened and/or closed.

The notebook 20 is shown as being open in FIGS. 2-4. The notebook 20 has a front cover 32 and a back cover 36. A spine 40 connects the front and back covers (32, 36). The covers (32, 36) and/or spine 40 may be rigid, flexible or may have both rigid and flexible portions. The covers (32, 36) and/or spine 40 may be made of various materials, including but not limited to paper, cardboard, plastic, leather, etc. As shown in FIG. 4, the notebook 20 has cardboard covers (32, 36) joined together with the spine 40 by tape 44. The tape 44 is flexible so as to allow the covers (32, 36) to be moved apart to open the notebook 20 and to be moved together to close the notebook 20. Other or additional materials, attachment means, and/or structures could be used to attach covers with a spine, including layers of paper, fabric, hinges of various materials, glue, lamination, etc.

As shown more clearly in FIG. 4, a binding 48 is connected with the covers (32, 36). Specifically and for example, a front portion 52 of the binding 48 is attached to and inside the front cover 32, and a back portion 56 of the binding 48 is attached to and inside the back cover 36. A central strip portion 60 of the binding 48 extends generally in parallel with the spine 40 but is not attached to the spine 40. A plurality of pages 64 are attached to the central strip portion 60, e.g., by a padding compound, glue or other adhesive. The pages 64 are attached such that individual pages 64 optionally can be completely removed, e.g., as shown in FIG. 2. When a page is stated herein to be “completely removed,” “removed cleanly” and the like, the page remains whole after removal and leaves no strip or other remnant of paper behind on the binding from which the page was removed. In various embodiments, the central strip portion 60 is at least partly flexible, so that at least part of the central strip portion 60 is capable of moving away from the spine 40 when the notebook 20 is opened, e.g., as shown in FIG. 4. Where the central strip portion 60 of the binding 48 is capable of at least partly moving away from the spine 40, pages 64 are allowed to lie flat when the notebook 20 is opened. Additionally, a user can more easily remove pages 64 from the binding 48 than would be the case where a notebook binding remains fixed relative to the notebook spine.

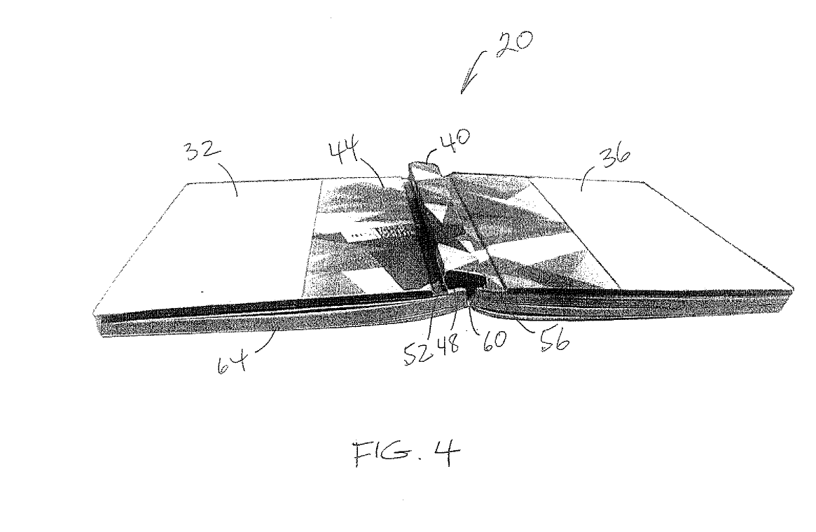

As shown in FIG. 3, a folder 70 is attached inside the notebook 20, e.g., adjacent the back cover 36. The folder 70 has a receiving layer 74 upon which one or more pages 64 that have been completely removed from the binding 48 may be placed. The folder 70 has a plurality of flaps, e.g., three flaps referred to collectively by reference number 78, that are openable away from the receiving layer 74 to allow placement of one or more removed pages 64 onto the receiving layer 74. In the present example embodiment, the flaps 78 include an upper flap 78a, a lower flap 78b, and a lateral flap 78c. The flaps 78 are closable over removed page(s) 64 placed on the receiving layer 74. The closed flaps 78 hold the page(s), whole and unfolded, in the folder 70. In various notebook embodiments, folder flaps may have various shapes, sizes, and/or angular orientation in relation to a receiving layer, cover and/or to one another. In various embodiments, flaps may at least partially overlap one another when closed over a receiving layer. In some embodiments, a folder may additionally or alternatively be provided in a notebook front cover. In various embodiments, removed pages placed in a notebook folder all fit within the notebook without being folded or wrinkled.

Notably, and referring again to FIG. 3, when the flaps 78 are open, the receiving layer 74 is exposed, e.g., so that a user optionally can position a removed page 64 onto the receiving layer 74 from a plurality of directions, e.g., from a direction generally perpendicular to the receiving layer 74, at an acute or oblique angle onto the receiving layer, etc. Additionally or alternatively, a user may choose, e.g., to slide a removed page 64 sideways onto the receiving layer 74.

In the present example embodiment, the flaps 78 are flexible, e.g., to allow for adjustment to accommodate various numbers and/or thicknesses of removed pages. The flaps 78 may be made of paper and optionally may be folded, e.g., along dashed lines 82 as shown in FIG. 3, so that the flaps 78 might provide depth in the folder 70 for storing a correspondingly thick stack of removed pages 64. In various embodiments, flaps may include more than one set of fold lines, to allow for a selection of depths to be provided in the folder. Other materials instead of or in addition to paper could be used for flaps and/or a receiving layer, including but not limited to plastic, fabric, etc. In various embodiments, flaps may have creases, scoring, etc. and/or may include extendible portions to change flap coverage areas and/or depth capacities.

The example notebook 20 is capable of holding a plurality of removed pages in the folder 70, without substantially changing the outer dimensions of the notebook 20 when the notebook 20 is closed and the elastic band 24 is applied over the covers (32, 36). Further, when all of the pages 64 have been removed from the notebook 20, all of the removed pages can be stored inside the closed notebook 20, and held inside the closed notebook 20 by the elastic band 24, without substantially changing the notebook's outer dimensions. In some embodiments in which the folder 70 is provided inside the back cover 36 and a user removes pages 64 from the back of the notebook 20, removal of pages close to the folder 70 can facilitate the availability of space in the folder 70 to store removed pages 64 without putting pressure on the binding 48. Similarly, if the folder 70 is provided inside the front cover 32, removing pages from the front of the notebook 20 can serve to make space available for storing pages 64 in the folder 70 without putting pressure on the binding 48.

In various implementations, a notebook may be made, e.g., using the following example method. It should be noted that various method steps and/or processes may be performed in sequence(s) that may differ from the sequence(s) described below. The method includes attaching a binding between two covers connected by a spine. The binding has a plurality of pages attached to and completely removable from a central strip portion of the binding. The method may also include using a padding compound, glue or other adhesive to attach the pages to the central strip portion of the binding. In some implementations, the binding is attached between the covers so as to leave the binding free of the spine, so as to allow at least part of the central strip portion of the binding to move, e.g., flex, away from the spine when the notebook is opened.

Making the notebook also includes affixing a folder on one of the covers. The folder has a plurality of flaps that may be opened to allow placement of one or more pages removed from the binding onto an exposed receiving layer of the folder. The flaps are closable over the placed page(s) to hold the placed page(s), whole and unfolded, inside the folder and inside the notebook. In some implementations, the method includes providing fold lines and/or scoring on the flaps for adjusting a depth of the folder. A band made, e.g., of elastic may be provided to position around the notebook, e.g., to retain any pages stored in the folder inside the notebook.

Various notebook embodiments provide pages that are easy to remove and that keep a clean edge when removed. The pages are detachable without the need for scoring or perforation of the pages. No paper strip or other residual paper is left behind in the notebook, in contrast to notebooks that have pages bound by a spiral or that have perforations along which a page must be torn to remove. Folder size and configuration make it easy to place a removed page into the folder, since a user may simply lay a page onto the folder and then close the flaps. In contrast, many currently available notebooks provide a pocket into which a sheet of paper may be inserted for storage. Such pockets tend to be too small to accommodate an entire, unfolded page. Additionally, where a pocket has an opening close to the spine of a notebook, a user can find it difficult to insert a sheet into the pocket. The lack of room can make it difficult, if not impossible, to fit an entire sheet of paper into the folder without wrinkling and/or folding the sheet.

The foregoing notebook embodiments make it possible to carry removed pages in the notebook without having to fold them. Some or all of the pages can be easily removed, e.g., for copying and/or scanning. Embodiments can be advantageous for users who want to scan or copy their notebooks, e.g., after all of the pages have been filled with content. All of the pages can be easily removed and fed, e.g., into a sheet-feed scanner, which can be reasonably priced and easy to set up and use. One example scanner is a Fujitsu® ScanSnap iX500 scanner. In some embodiments, the scanner may input scanned pages to an optical character recognition (OCR) software program, e.g., available from Evernote®, to make the scanned pages text-searchable. When, e.g., all of the original pages have been removed from a notebook and digitized, the notebook can serve as a handy folder or container, e.g., for storage purposes. The three-flap folder and strap make it possible for the notebook, even though emptied of pages, to still be useful, e.g., as a simple “box” or “portfolio” that can hold the original pages for posterity.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or, for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A notebook comprising:
two covers connected by a spine;
a binding fixedly connected with each cover and having a central strip portion to which a plurality of pages are removably attached;
the binding and pages housed between the covers when the notebook is closed, at least part of the central strip portion of the binding being capable of movement away from the spine when the notebook is opened; and
a folder inside the notebook adjacent one of the covers, the folder having a plurality of flaps openable to allow placement of one or more of the pages onto the folder when the one or more pages have been removed from the binding, the flaps closable over the placed one or more pages to retain the one or more pages, whole and unfolded, in the folder.

2. The notebook of claim 1, wherein the central strip portion of the binding comprises a padding compound from which the pages are completely removable.

3. The notebook of claim 1, further comprising an elastic band positionable around the closed notebook.

4. The notebook of claim 1, wherein the folder comprises a receiving layer for placement of the one or more pages thereon;
the flaps including an upper flap, a lower flap, and a lateral flap near the upper and lower flaps, each flap extending from the receiving layer, each flap openable away from the receiving layer and closable over the receiving layer and removed pages placed on the receiving layer.

5. The notebook of claim 1, wherein the flaps are adjustable to accommodate a thickness of the placed one or more pages.

6. The notebook of claim 5, wherein the flaps comprise fold lines and/or scoring to facilitate flap adjustment.

7. The notebook of claim 1, wherein the flaps are flexible.

8. The notebook of claim 1, wherein at least some pages removed from the binding are storable in the folder without substantially changing outer dimensions of the notebook when the notebook is closed.

9. The notebook of claim 1, wherein outer dimensions of the notebook when closed are not substantially changed by removing all of the pages and storing all of the removed pages between the covers.

10. The notebook of claim 1, wherein the pages lie flat when the covers are completely opened.

11. A notebook comprising:
two covers connected by a spine;
a binding fixedly connected to each of and between the covers, the binding having a central strip portion that is free in relation to the spine;
a plurality of pages each having an edge attached to the central strip portion and completely removable therefrom;
the binding and pages housed between the covers when the notebook is closed, at least part of the central strip portion of the binding capable of movement away from the spine when the notebook is opened; and
a folder inside the notebook on one of the covers, the folder having dimensions configured to hold one or more pages removed completely from the central strip portion of the binding, the one or more pages being retainable whole and unfolded in the folder;
the folder having a plurality of flaps openable to allow placement of the one or more removed pages onto an exposed receiving layer of the folder, the flaps closable over the one or more placed pages to hold the one or more placed pages in the folder.

12. The notebook of claim 11, wherein the central strip portion of the binding comprises an adhesive from which the pages are completely removable.

13. The notebook of claim 11, further comprising an elastic band positionable around the closed notebook.

14. The notebook of claim 11, wherein the pages lie flat when the covers are completely opened.

15. A method of making a notebook comprising:
fixedly attaching a binding to each of and between two covers connected by a spine, the binding having a plurality of pages attached to and completely removable from a central strip portion of the binding; and
affixing a folder on one of the covers, the folder having a plurality of flaps openable to allow placement of one or more pages removed from the binding onto an exposed receiving layer of the folder, the flaps closable over the one or more placed pages to hold the one or more placed pages, whole and unfolded, inside the folder and inside the notebook.

16. The method of claim 15, further comprising attaching the pages to the central strip portion of the binding, the attaching performed using a padding compound.

17. The method of claim 15, further comprising providing on the flaps fold lines and/or scoring for adjusting a depth of the folder.

18. The method of claim 15, wherein attaching the binding comprises leaving the binding at least partly free of the spine so as to allow at least part of the central strip portion of the binding to flex away from the spine when the notebook is opened.

19. The method of claim 18, performed to allow the pages to lie flat when the notebook is open.

20. The method of claim 15, further comprising providing an elastic band to position around the closed notebook.
